(19) United States
(12) Patent Application Publication
(10) Pub. No.: US 2013/0100268 A1
(43) Pub. Date: Apr. 25, 2013

(54) EMERGENCY DETECTION AND RESPONSE SYSTEM AND METHOD

(71) Applicant: UNIVERSITY HEALTH NETWORK, Toronto (CA)

(72) Inventors: Alex MIHAILIDIS, Toronto (CA); Yani A. IOANNOU, Toronto (CA); Jennifer BOGER, Toronto (CA); James E. GASTLE, Lakefield (CA)

(73) Assignee: UNIVERSITY HEALTH NETWORK, Toronto (CA)

(21) Appl. No.: 13/655,920

(22) Filed: Oct. 19, 2012

Related U.S. Application Data
(63) Continuation-in-part of application No. PCT/CA2011/001168, filed on Oct. 21, 2011.
Application No. PCT/CA2011/001168 is a continuation-in-part of application No. 12/471,213, filed on May 22, 2009, now Pat. No. 8,063,764.
(60) Provisional application No. 61/560,640, filed on Nov. 16, 2011.
(60) Provisional application No. 61/071,939, filed on May 27, 2008.

(51) Int. Cl. G08B 21/02

(52) U.S. Cl. CPC G08B 21/02
USPC 348/77

(57) ABSTRACT

Disclosed herein are automated emergency detection and response systems and methods, in accordance with different embodiments of the invention. In some embodiments, a system is provided for detecting and responding to a potential emergency event occurring in respect of a user in or near a designated area. The system comprises one or more sensors disposed in or near the area and a controller operatively coupled to the one or more sensors to receive sensor data therefrom indicative of the user's condition. The controller is further operatively coupled to a designated device in or near the area, operation of the designated device previously identified to effect capture of sensor data. The controller operating on stored statements and instructions to process the sensor data in automatically identifying the event therefrom, communicate a command to the designated device to alter operation thereof based on the previously identified effect so to improve capture of additional sensor data, process the additional sensor data to determine a level of assistance required by the user in response to the event.

### CROSS REFERENCE TO RELATED APPLICATIONS

This application is a Continuation-in-Part of copending International Patent Application No. PCT/CA2011/001168, filed Oct. 21, 2011, which is a Continuation-in-Part of U.S. application Ser. No. 12/471,213 (Now U.S. Pat. No. 8,063,764), filed May 22, 2009, which claims priority to U.S. Provisional Application No. 61/071,939. This application also claims priority to U.S. Provisional Application No. 61/560,640, filed Nov. 16, 2011. The disclosures set forth in the referenced applications are incorporated herein by reference in their entireties.

### FIELD OF THE DISCLOSURE

The present disclosure relates to emergency detection systems, and in particular, to automated emergency detection and response systems and methods.

### BACKGROUND

Falls in the home are the most common cause of injury among older adults or those with disabilities, and are a significant challenge to older adults maintaining their mobility, independence and safety. Even concerns as to a person's potential likelihood of falling can significantly affect this person's sense of independence and safety, often leading to such individuals being prematurely transferred to a long term care facility or the like. To address this issue, several personal emergency response (PERS) products have been developed that allow an older adult to call for help using a wearable panic button. However, these devices often are ineffective because users forget or refuse to wear the button, user training is required, and the system cannot be operated if the person is severely injured or left unconscious. These limitations are further exacerbated if the older adult has a cognitive impairment, such as Alzheimer's disease.

Therefore, there remains a need for an emergency detection and response system and method that overcomes at least some of the drawbacks of known techniques, or at least, provides a useful alternative.

This background information is provided to reveal information believed by the applicant to be of possible relevance. No admission is necessarily intended, nor should be construed, that any of the preceding information constitutes prior art.

### SUMMARY

Some aspects of this disclosure provide an emergency detection and response system and method.

In accordance with one embodiment, there is provided an emergency detection and response system configured for communication with at least one smart-home device.

In accordance with another embodiment, there is provided a system for detecting and responding to a potential emergency event occurring in respect of a user in or near a designated area, the system comprising: one or more sensors disposed in or near the area; a controller operatively coupled to said one or more sensors to receive sensor data therefrom indicative of the user's condition, said controller further operatively coupled to a designated device in or near the area, operation of said designated device previously identified to effect capture of said sensor data, said controller operating on stored statements and instructions to: process said sensor data in automatically identifying the event therefrom; communicate a command to said designated device to alter operation thereof based on said previously identified effect so to improve capture of additional sensor data; and process said additional sensor data to determine a level of assistance required by the user in response to the event.

In accordance with another embodiment, there is provided a method for detecting and responding to a potential emergency event occurring in respect of a user in or near a designated area, the method automatically implemented by a computing device having access to stored statements and instructions to be processed thereby, the method comprising: monitoring sensor data captured from one or more sensors disposed in or near the designated area and indicative of the user's condition; identifying the event from said monitored sensor data; communicating a preset command to a designated device in or near the area, the device previously identified to effect capture of said sensor data, said command altering operation of said designated device in a manner previously identified to reduce said effect and thus optimize capture of additional sensor data; and processing said additional data to determine a level of assistance required by the user in response to the event.

In accordance with another embodiment, there is provided a computer readable medium having statements and instructions stored thereon for operation by a processor of a computing device to automatically detect and respond to a potential emergency event occurring in respect of a user in or near a designated area by: monitoring sensor data captured from one or more sensors disposed in or near the designated area and indicative of the user's condition; identifying the event from said monitored sensor data; causing communication of a preset command to a designated device in or near the area, the device previously identified to effect capture of said sensor data, said command altering operation of said designated device in a manner previously identified to reduce said effect and thus optimize capture of additional sensor data; and processing said additional data to determine a level of assistance required by the user in response to the event.

In accordance with another embodiment, there is provided a system for detecting and responding to a user having a fall in or near a designated area, the system comprising: a detection module operatively coupled to one or more sensors disposed in or near the area to capture sensor data and detect the fall therefrom, said one or more sensors comprising at least one video sensor; a controller operatively coupled to said detection module to implement a designated response protocol upon the fall being detected, said controller further operatively coupled to a designated device in or near the area, said response protocol comprising automatically: evaluating a level of assistance required from said sensor data; dispatching a request for assistance in accordance with said level of assistance required; and communicating a command to said designated device to alter operation thereof based on stored preset home automation rules associated with said response protocol.

Other aims, objects, advantages and features will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a schematic diagram of an emergency detection and response system, in accordance with one embodiment of the invention;

FIG. 2 is a schematic diagram of the system of FIG. 1, further comprising respective response modules for each detection module, in accordance with one embodiment of the invention;

FIGS. 3A and 3B are operational perspective views of an emergency detection and response system, in accordance with an exemplary embodiment of the invention;

FIGS. 4 and 5 are schematic views of portions of the system of FIG. 3;

FIG. 6 is a flow diagram showing an operative mode of the system of FIG. 3A, in accordance with an exemplary embodiment of the invention;

FIGS. 7A and 7B are raw and processed video images, respectively, captured by an emergency detection and response system in tracking a user in a predetermined area and in identifying regular activity, in accordance with one embodiment of the invention;

FIGS. 8A and 8B are raw and processed video images, respectively, captured by the emergency detection and response system of FIGS. 7A and 7B, identifying a possible emergency event, in accordance with one embodiment of the invention;

FIG. 9 is a schematic diagram of an emergency detection and response system, in accordance with one embodiment of the invention, wherein the system is configured for communication with at least one smart-home device;

FIG. 10 is a schematic diagram of an emergency detection and response system, in accordance with one embodiment of the invention, further comprising a smart-home module; and

FIG. 11 is a schematic diagram of an emergency detection and response system, in accordance with one embodiment of the invention, further comprising a distinct smart-home controller.

### DETAILED DESCRIPTION

It should be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical or electrical connections or couplings. Furthermore, and as described in subsequent paragraphs, the specific mechanical or electrical configurations illustrated in the drawings are intended to exemplify embodiments of the disclosure. However, other alternative mechanical or electrical configurations are possible which are considered to be within the teachings of the instant disclosure. Furthermore, unless otherwise indicated, the term “or” is to be considered inclusive.

Described below are various embodiments of an emergency detection and response system and method, wherein one or more sensors in or near a given area can be used to detect an adverse situation in this area and respond accordingly. For example, in one embodiment, the sensor may be used to identify an emergency event, wherein the system may be configured to implement a response protocol upon such identification. In some embodiments, the system may be communicatively coupled to one or more designated devices, such that, upon identifying an adverse event, these devices may be automatically activated, deactivated and/or controlled by the system in implementing, facilitating and/or improving a potential efficiency of a given response protocol. For example, where event detection relies on the capture and processing of sensor data in the area (e.g. video and/or audio), and where an assessment as to a level of assistance required in response to the detected event is automatically determined via the subsequent processing of additional sensor data, the automated control of the designated device(s) may allow to improve or optimize capture of this additional data, and thus improve accuracy in selecting an appropriate response protocol. For example, as will be described in greater detail below, where a response protocol may rely on audio capture, such as audio cues, commands and/or a virtual dialogue with the user, the system may be configured to automatically turn off one or more devices identified and designated as a potential source of audio interference (e.g. TV, radio, noisy appliances, etc.), be it in the area of the user, or again throughout the dwelling. The system may be further or alternatively configured to control one or more of lighting, gas, power, water, locks and the like, alone and/or in various combinations, to achieve various effects, such as for example, improve safety for the occupant and/or assist with response coordination with onsite responders (e.g. family, friend, emergency personnel, etc.). For instance, lighting adjustments may improve capture of additional video data, which may assist in the characterization of the event and the level of assistance required.

Also described below are various embodiments of an emergency detection and response system and method, wherein multiple sensors distributed throughout one or more predetermined areas can be jointly used in detecting an adverse situation in one of these areas and responding accordingly. For example, in one embodiment, the various sensors may be used to generate respective data sets to be processed in identifying an emergency event. For example, each data set may be processed locally and/or centrally to identify an emergency event, referred to hereinbelow in various examples as a local emergency factor, or again be processed in defining a globally assessed emergency event or factor. Upon identification of an emergency event from this data, the system can be configured to implement an appropriate response protocol. For example, in some embodiments, an appropriate response may be established based on a single data set upon this data set identifying an emergency event of concern, whereas in other embodiments, two or more data sets, for example as generated from distinctly located sensors, may be used to improve emergency identification and response.

In one such embodiment, respective data sets may be compared and ranked, whereby a highest ranking data set (or emergency factor) may be used to further identify the emergency event and/or implement an appropriate response protocol. For example, where audio signals are captured by two or more audio sensors distinctly located in or near a predetermined area where an emergency event may have taken place, the audio signals captured by each of these sensors may be ranked based on one or more ranking criteria (e.g. signal strength, background noise, proximity as defined by complimentary sensory means, speech recognition reliability, etc.), and a response protocol implemented as a function of this highest ranking signal. In some embodiments, this protocol may involve the dispatch of an emergency communication to an external party based, at least in part, on a content of the highest ranking audio signal (e.g. identified speech element/spoken word(s), high intensity sound (yell, break-in, etc.)). In some embodiments, this protocol may rather or also involve prompting a user in or near the predetermined area via a prompting device associated with a highest ranking sensor (i.e. the sensor having produced the highest ranking data set), whereby a user response captured by the highest ranking sensor and/or other sensors/input devices associated therewith (e.g. commonly located) may be used to further ascertain the situation in implementing the response protocol.

In other such embodiments, respective data sets may rather or also be compared and merged based on overlap identified therebetween, thereby allowing to produce a more accurate rendition of the emergency event taking place, and thus leading to the rendition of a more accurate or informative emergency factor. For example, where imaging signals are captured by two or more distinctly disposed imaging sensors (e.g. video, infrared (IR), multispectral imaging, heat sensor, range sensor, microphone array, etc.), data sets representative thereof may be compared to identify overlap therebetween (e.g. via computer vision techniques, 2D/3D mapping, etc.) to enhance emergency identification and thus improve response thereto. For instance, a merged data set may provide for a more accurate depiction or imaging of the event, for example, where different imaging sensors may be used to piece together a more complete image of a user in distress located in partial view of these sensors. Alternatively, or in addition thereto, merged data sets may be used to improve locational techniques for accurately identifying a location of such a user, for example, using various 2D/3D mapping techniques.

As will be appreciated by the skilled artisan, both data set ranking and data set merging may be implemented in concert to increase system accuracy, or may be implemented independently depending on the application at hand, or again exclusively depending on the intended application for the system.

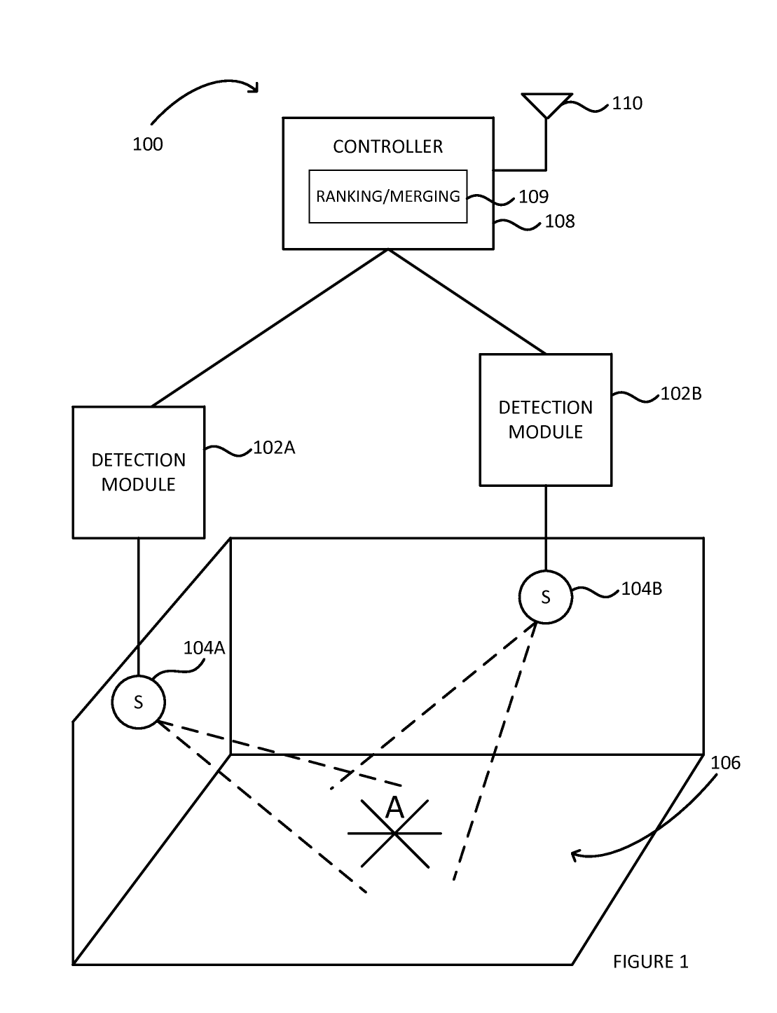

With reference now to FIG. 1, and in accordance with one embodiment of the invention, an emergency detection and response system, generally referred to using the numeral 100 and in accordance with one embodiment of the invention, will now be described. The system 100 generally comprises one or more detection modules, such as modules 102A and 102B, each adapted for operative coupling to one or more sensors, as in sensors 104A and 104B, respectively, which are distinctly disposed in or near a predetermined area 106 to detect emergency events occurring in or near this area (e.g. at location A). The sensors 104A, 104B, in concert with detection modules 102A, 102B, are generally configured to generate respective data sets representative of a detected event.

It will be appreciated that while distinct detection modules are depicted in this example to schematically represent the generation of distinct data sets representative of distinct data perspectives, viewpoints and/or origins as prescribed by the respectively located sensors from which they originate, various data/signal processing architectures and platforms may be considered herein without departing from the general scope and nature of the present disclosure. For example, distinctly located sensors may themselves be configured to generate respective data sets via integral detection modules, or again be configured to communicate raw or pre-processed data to a common detection module for further processing, albeit retaining some original signature in identifying the sensor from which such data originated. These and other such permutations will be readily apparent to the person of ordinary skill in the art, and is thus considered to fall within the scope of the present disclosure.

The system 100 further comprises one or more controllers 108 operatively coupled to each detection module 102A, 102B and configured to compare each of the respective data sets (e.g. via ranking and/or merging module 109) and implement a response protocol as a result of this comparison and as a function of at least one of these respective data sets. For example, in one embodiment, the controller 108 may be configured to process locally derived emergency factors provided by the respective data sets of each detection module to select and implement an appropriate response protocol. Alternatively, the controller may derive each local emergency factor from raw and/or processed data in making this comparison. In yet another embodiment, the controller may rather derive a global emergency factor from distinctly provided data sets, for example where such data sets are compared for ranking and/or merging purposes. As will described in greater detail below, various techniques may be employed to achieve intended results, such as machine learning techniques, artificial intelligence and/or computer vision techniques implemented on the local and/or global data set(s).

In one embodiment, the controller 108 may be configured to dispatch an emergency message or warning to an external user, such as a friend, family member, neighbour, medial practitioner, security unit, external emergency response unit and the like, or even the home owner himself should an event be detected while the owner is out of the house, via one or more wired and/or wireless communication networks, this functionality commonly depicted in this illustrative embodiment by antenna 110. Examples of such communication links may include, but are not limited to, a landline phone link, a cellular phone or data link, a residential Wi-Fi network in concert with an associated communication platform (e.g. home computer network for dispatching an email, text message or the like), and the like, as will be readily appreciated by the skilled artisan. Alternatively, or in addition thereto, a given response protocol may include the dispatch of related sensory data, be it raw, pre-processed and/or processed data, for example in qualifying the detected emergency. Dispatched data may include, but is not limited to, audio data, for example as recorded in identifying the emergency event and/or as a response to an emergency initiated prompt (discussed below), video/imaging data depicting the user's emergency/condition, positional data to identify a location of the user within the area or amongst plural areas commonly monitored by the system, environmental data, etc.

Again, as will be appreciated by the skilled artisan, while a singular controller 108 is depicted in this example to interface with respective detection modules 102A, 102B, alternative processing architectures may also be contemplated without departing form the general scope of the present disclosure. For example, the computational and/or communicative functionalities of the controller 108 as described in the context of this example, may be singularly implemented within a same global control module, wherefrom emergency detection and response protocols may be commonly initiated in respect of a given area, but also in respect of plural areas commonly monitored by an expanded embodiment of system 100. In other embodiments, these functionalities may rather be implemented locally and/or distributively between control modules respective to each detection module, that is, wherein a network of emergency detection units may be configured to cooperate in processing respective data sets and implementing a common response protocol. In such examples, each detection unit may comprise a respective sensor(s), processor, data storage device and network communication interface to implement various computational and communicative functionalities of the system 100 locally. Accordingly, while the below examples will describe various modular architectures for the acquisition, processing and manipulation of sensory data, and response protocols implemented as a function thereof, it will be appreciated that such modularity is only provided for the purpose of clarifying various functions and features of the herein described embodiments of the invention, and should thus not be taken as limiting to the scope of the present disclosure. For example, the controller may be described as comprising a merging module and/or a ranking module, as introduced above and further described below, for the purpose of managing multiple data sets. Clearly, such processing modules may be implemented independently within the context of a common controller or control module, or again implemented distributively within the context of two or more central and/or distributed controllers. Furthermore, the modularity of the processing techniques contemplated herein may be more or less defined in different embodiments, whereby data may be processed in parallel, in sequence and/or cooperatively depending on the intended outcome of the system's implementation.

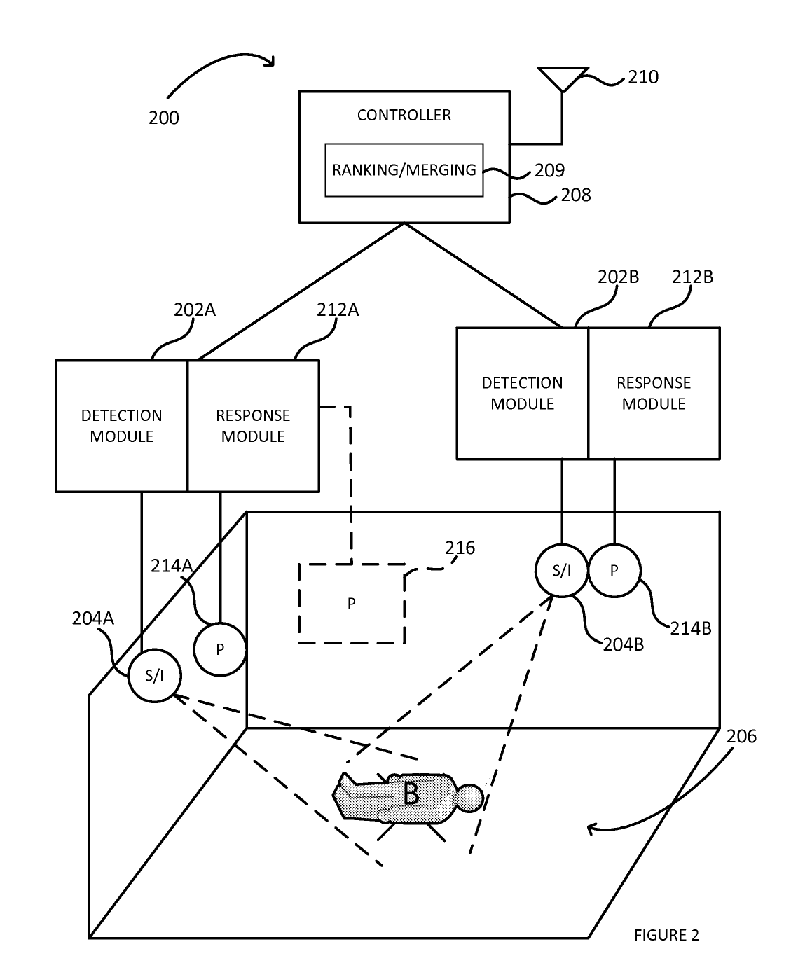

With reference now to FIG. 2, and in accordance with another embodiment of the invention, a similar system 200, will now be described. In this embodiment, the system 200 again generally comprises two or more detection modules 202A, 202B each adapted for operative coupling to one or more sensors, as in sensors 204A and 204B, respectively, which are distinctly disposed in or near a predetermined area 206 to detect emergency events occurring in or near this area (e.g. in respect of user B). The sensors 204A, 204B, in concert with detection modules 202A, 202B, are generally configured to generate respective data sets representative of a detected event.

The system 200 further comprises one or more controllers 208 operatively coupled to each detection module 202A, 202B and configured to compare each of the respective data sets (e.g. via ranking and/or merging module 209) and implement a response protocol as a result of this comparison and as a function of at least one of these respective data sets.

In this embodiment, a respective response module 212A, 212B is associated with each of the detection modules 202A, 202B and adapted for operative coupling to a respective prompting device 214A, 214B and input device, which in this embodiment, is commonly operated via sensors 204A, 204B. Accordingly, upon the controller 208 processing each data set, a response protocol may be selected and implemented in which the user B is first prompted via an appropriate response module and prompting device to provide a user input in return, which user input can then be relayed to the controller (or local response module) to refine, adjust and/or terminate the response protocol. For example, in one embodiment, a highest ranking data set may be used to identify a most reliable sensory location (e.g. from which a user response may have the greatest likelihood of being understood or captured by the system 200). Based on this ranking, a response module and prompting device associated with this location (e.g. associated with a highest ranking detection module/data set) may be operated by the controller to proceed with the next step of the response protocol. In the examples described below, a prompt is provided via a selected prompting device, and a user input is recorded in response thereto. In the event where the sensors 204A, 204B include an audio sensor (e.g. microphone, microphone array), this audio sensor may double as input device for recording the user's response.

It will be appreciated that various device combinations may be used to achieve this result without departing from the general scope and nature of the present disclosure. For example, a combined detection and response unit encompassing the functionality of both detection and response modules may be considered, as can a self-contained processing unit further encompassing at least some of the processing functionalities of the controller, to name a few. Furthermore, and as depicted by prompting device 216, an additional or alternative prompting device, such as a visual prompting device for the hearing impaired (e.g. communal or dedicated screen) may be used by respective response modules or shared between them in prompting a user response.

In one embodiment, the controller 208 may be configured to dispatch an emergency message or warning to an external user (e.g. via antenna 210), based on the processed sensory data and/or user responses.

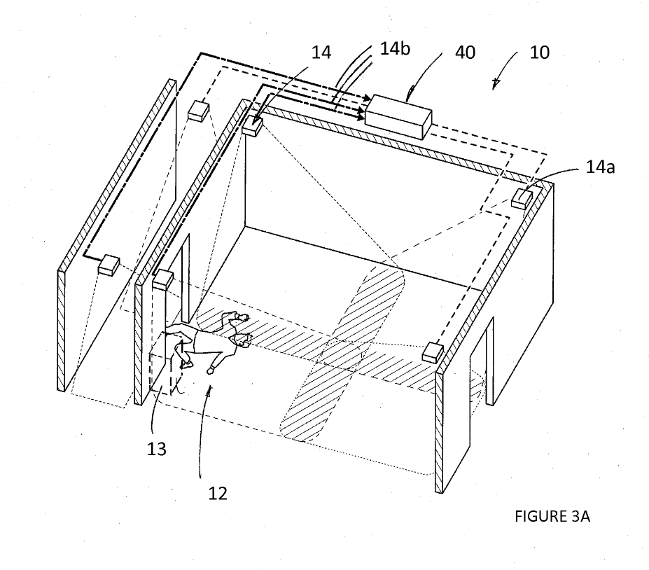

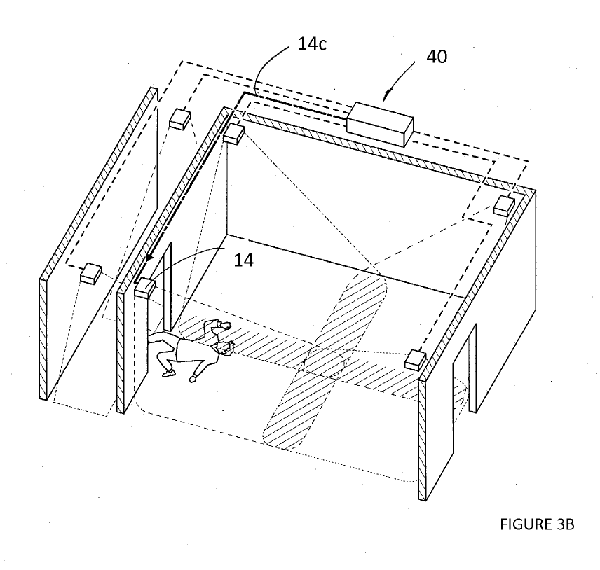

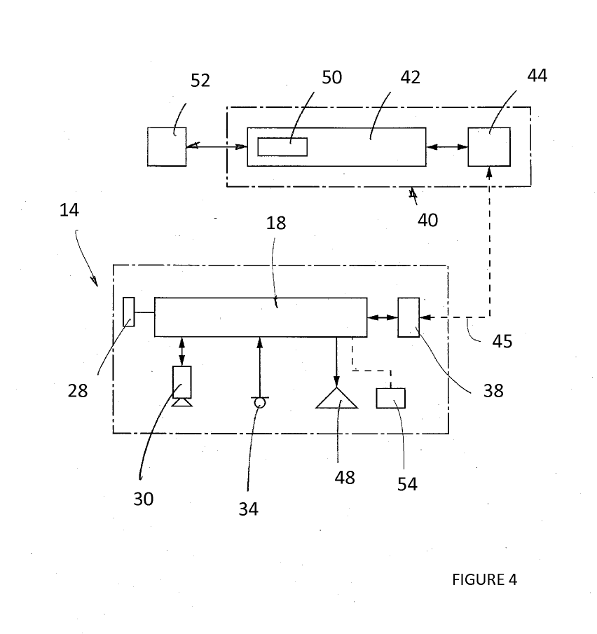

With reference now to FIGS. 3 to 5, and in accordance with an exemplary embodiment of the invention, an emergency detection and response system 10 will now be described. The system 10 is generally provided for detecting and responding to emergency events occurring in a predetermined local area 12. The system includes a plurality of local emergency detection and response units (or hereinafter referred to as EDR units) 14 positioned in the local area 12.

Each EDR unit 14 includes one or more local sensing agents or sensors 16 and a local detection manager 18 (i.e. detection module). The local detection manager includes a local processor 20 with a control module 22 which communicates with the local sensing agents 16, including a local video sensing agent 24, a local audio sensing agent 26 and, in this example, an environmental sensing agent 28. Each local sensing agent is operable to detect a change in a given emergency factor in the local area and to report to the control module accordingly. Each local sensing agent conveys data representative of the change in the emergency factor to the control module 22.

In this case, the local video sensing agent 24 includes a video camera 30 monitored by a video processing module 32. As will be described, the video processing module 32 is thus operable to detect a change in a given emergency factor in the local area 12, in this case, for example, by detecting the presence of a person, subject, user or other object in the local area 12. In this case, the person may include, among others, a patient in a healthcare facility, or a resident of a residential or other facility, with or without disabilities, or others who may be prone to falling or to disorientation or suffer from other condition worthy of monitoring and response, in the manner to be described. Also in this case, the audio sensing agent 26 includes a microphone 34 monitored by a speech dialog module 36. As will be described, the speech dialog module 36 is thus operable to detect a change in a given emergency factor in the local area 12, in this case, for example, by detecting a verbal message from a person in the local area, which may be in response to automated questions being asked by the EDR units 14 to determine the severity of the emergency, as will be described. In both cases, the video processing module 32 and the speech dialog module 36 convey data to the control module 22 for further processing. In this case, the control module 22, the video processing module 32, and the speech dialog module 36 may be applications running on the local processor 20 or be one or more distinct processors, such as by way of video cards and the like.

The control module 22 is, in turn, operable to assign a value to the emergency factor according to the data received from one or more of the video processing module, the speech dialog module and the environmental monitor 28, as the case may be.

A local interface agent 38 is provided for issuing, on a data path, one or more event status signals including the assigned value for the emergency factor.

A central location controller unit 40 is provided in the form of a central server, with one or more central processors 42 communicating with a central interface agent 44 to receive event status messages therefrom on a communication channel shown at 45. In this case, the central and local interface agents may include wired or wireless network cards, RFID tags, Bluetooth, or other forms of transmitter receivers as the case may be. As will be appreciated by the skilled artisan, however, while a central controller is depicted in this particular embodiment, respective controllers may alternatively be dispersed along with each EDR, or again clustered into groups or the like to provide a distributed emergency detection and response network, or the like.

The system 10 is operable in a communication network which, in this example, is computer implemented and may be provided in a number of forms, by way of one or more software programs configured to run on one or more general purpose computers, such as a personal computer, or on a single custom built computer, such as a programmable logic controller (PLC) or a digital signal processor (DSP), which may be dedicated to the function of the system alone or again form part of or cooperate within the context of a more extensive smart home network or system. A system controlling such a communication network may, alternatively, be executed on a more substantial computer mainframe. The general purpose computer may work within a network involving several general purpose computers, for example those sold under the trade names APPLE or IBM, or clones thereof, which are programmed with operating systems known by the trade names WINDOWS, LINUX or other equivalents of these. The system may involve pre-programmed software using a number of possible languages or a custom designed version of a programming software. The computer network may be include a wired local area network, or a wide area network such as the Internet, or a combination of the two, with or without added security, authentication protocols, or under “peer-to-peer” or “client-server” or other networking architectures. The network may also be a wireless network or a combination of wired and wireless networks. The wireless network may operate under frequencies such as those referred to as ‘radio frequency’ or “RF” using protocols such as the 802.11, TCP/IP, BLUE TOOTH and the like, or other wireless, satellite or cell packet protocols. While the assembly 10 collects location data from the EDR units 14, each EDR alone or the central server 40 may have the ability to determine its location within the local area by use of other locating methods, such as by the use of network addresses, GPS positions or the like.

Each local EDR unit 14 further includes a local emergency event response agent or module 46 for responding to at least one person in or near the predetermined local area (e.g. via a dedicated or shared prompting device and input device). In this case, the emergency event response agent is provided by the speech dialog module 36 and a loudspeaker 48.

In this case, each local EDR unit 14 includes a housing 14a containing the local processor 20, the control module 22, the video camera 30, the video processing module 32, the speech dialog module 36, the microphone 34 and the loudspeaker 48. However, other variations may see one or more of these components being located outside the housing 14a, as desired. If desired, the surface of the housing 14a may be paintable, allowing for custom colouring of the housing according to the décor of a monitored location. The housing may also be provided in varying shapes and styles creating different options for the product's appearance, as desired. To guard against the possibility of a power outage, each EDR unit may be provided with a backup battery.

As will be described below, the central location controller unit 40 and/or the EDR units 14 are operable for classifying the assigned value of the emergency function to form an assigned value classification and for initiating the local emergency event response agent 46 to implement a response protocol according to the assigned value classification.

The central processor 42 includes a ranking agent 50 for ranking status signals being received from more than one local EDR unit 14 in the same predetermined local area 12.

The ranking agent 50 is operable to rank each of the EDR units 14 according to one or more ranking criteria. The central processor is thus operable to select one of the EDR units 14 according to the ranking as an “active” EDR unit to initiate the emergency event response protocol. Alternatively, one or more of the EDR units themselves may be configured to select an “active” EDR unit. In this case, the data paths 14b may be configured to form a local emergency and detection and response network, in which the local emergency detection and response units are each operable for exchanging the assigned values from one another to form an assigned value group. In this case, one or more of the local emergency detection and response units being operable to select an active emergency detection and response unit according to a ranking of individual values in the value group.

In this case, at least one emergency factor may include a plurality of video variables and/or thresholds, a plurality of audio variables and/or thresholds, and a plurality of environmental variables and/or thresholds. The environmental variables and/or thresholds may include, but are not limited to, temperature, atmospheric pressure, humidity, smoke concentration, carbon monoxide concentration, oxygen concentration, and/or environmental pollutant concentration, for example. Other environmental variables will be readily apparent to the person of ordinary skill in the art, and are therefore intended to fall within the general scope and nature of the present disclosure.

The ranking agent 50 may access and compare a plurality of emergency factors received from the plurality of reporting local emergency detection and response units 14. The emergency factor may include, in this case, a video image, the variable including size, shape, and motion of object being tracked. Alternatively, the emergency factor may include an audio signal, the variable including amplitude and type of the audio signal.

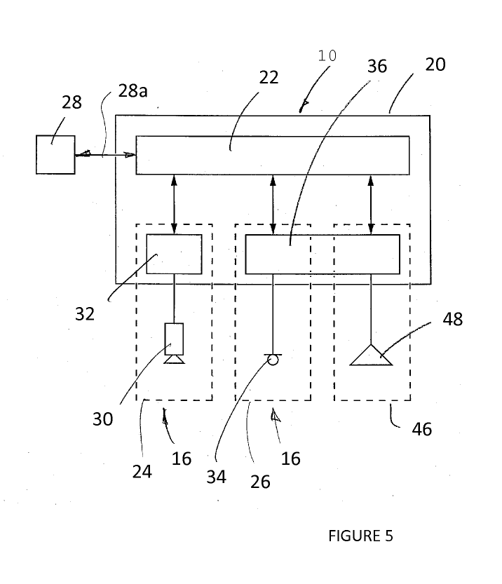

Thus, FIGS. 3 to 5 shows a general schematic of the various parts of a single unit, while FIG. 6 is a flow diagram outlining an exemplary decision-making process performed by the central server, to communicate with multiple EDR units simultaneously, in accordance with one embodiment.

The system 10 is configured so that the EDR units 14 may be located throughout a person's living space. The central server 40 makes overall decisions about which EDR unit 14 is actively monitoring or communicating with the human user at a given point in time. In the event of an emergency, the central server 40 may also facilitate communications with the outside world (e.g. contact a neighbour, relative or 911), by way of an external interface unit 52, for example.

Each EDR unit 14 may thus include one or several hardware components which may be installed in a common housing, such as one or more cameras (e.g. webcam or ‘steerable’ camera, infrared or multispectral imaging device, heat sensor, range sensor, etc.) one or more small loudspeakers, a single, multiple or small array of microphones, a computer processor, or an environmental monitor, such as a smoke and/or carbon monoxide detector.

Each EDR unit 14 may be portable or mobile, such as on a movable robot, or it may be stationary and installed in an appropriate location in a user's house or long-term care facility, such as on the ceiling of the living room or bedroom. In one example, the EDR unit, or a component thereof, may be mounted on the user. This might include a blood pressure or heart rate monitor, or the like.

The EDR unit 14 may use the camera(s) or microphone(s) to monitor the living environment of a human subject in real-time. The camera may be fixed within the housing, with a static field of view, or ‘steerable’ allowing it to follow the movement of a given subject. The local processor 20 in this case performs real-time analysis of the video and audio inputs to determine if an emergency event, such as a fall, has occurred. In the event of an emergency, the EDR unit 14 can communicate with the subject via the microphone 34 and loudspeaker 48 and initiate a dialog using speech recognition software. Communicating with the subject in this way allows the system to determine the level of assistance required. If external assistance is required (e.g. from relatives, neighbours or emergency services), the local processor 20 can relay this information to the central server 40 located at a convenient location in the house or other facility. Information between the local processor 20 and the central server 40 can occur via either a standard wired or wireless (e.g. Wi-Fi) communication network. The server may send information about an emergency event to the outside world via a variety of possible communication methods (e.g. landline or cell phone network, text messaging, email), via the external interface 52.

It should be noted that, in one example, the system 10 may ensure that the privacy of the subject is maintained at all times by configuring the local processor 20 to relay only computer vision and speech recognition results, as well as information about a possible emergency event, to the central server, but not any of the original video or audio information without express permission from the occupant either at setup and/or during implementation of the emergency response protocol. In another example, original video or audio information may be relayed to the central server for further processing, as well as other or alternative types of data such as blob information, feature vectors, etc., which data may allow an onsite respondent to better understand and prepare for the situation.

In this example, the environmental sensing agent 28 or Environmental Monitor may include sub-components such as a smoke detector and a carbon monoxide detector. Thus, in the event of a smoke, fire or carbon monoxide emergency the Environmental Monitor may also relay this information to the appropriate emergency services via the central server 40.

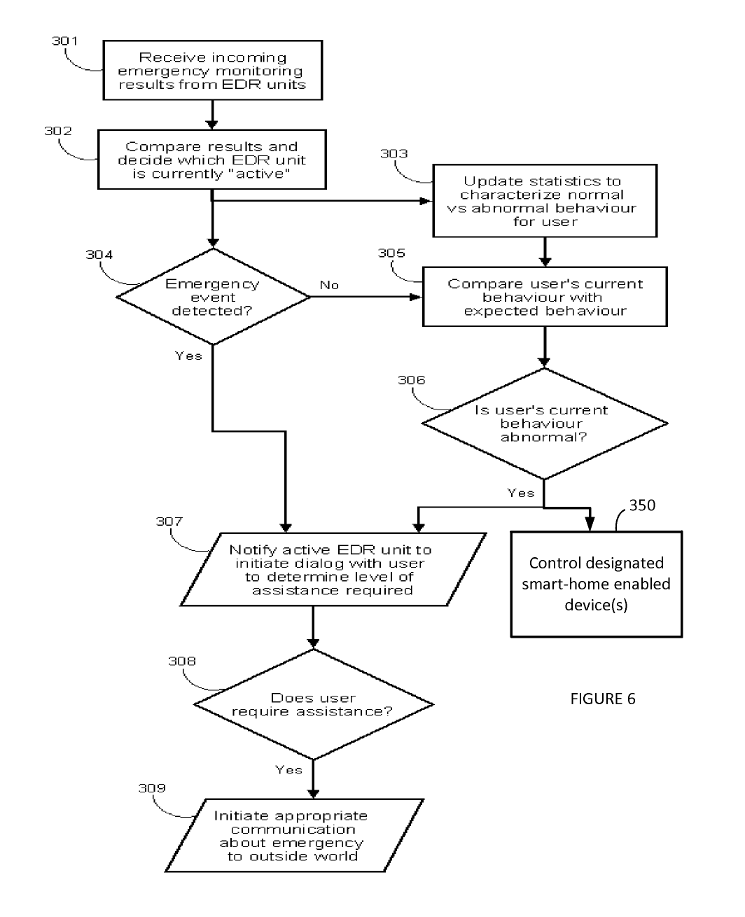

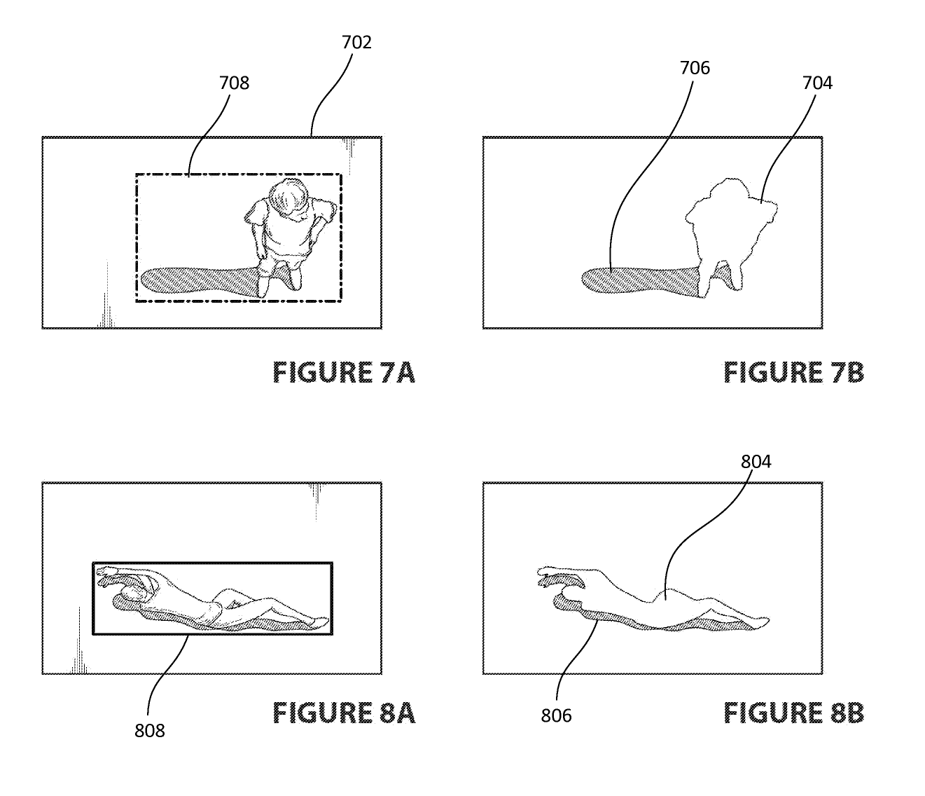

In one embodiment, the video processing module 32 takes real-time video input from the video camera 30, and performs computer vision algorithms to determine if an emergency has occurred. The employed computer vision algorithms may include object extraction and tracking techniques such as adaptive background subtraction, color analysis, image gradient estimation, and connected component analysis. These techniques allow the system to isolate a human subject from various static and dynamic unwanted features of the video scene, including the static background, dynamic cast shadows and varying light conditions. As such, characteristics of the subject's movement, posture and behaviour may be monitored in real-time to determine if an emergency (e.g. a fall) has occurred. The video processing module 32 may relay information of this emergency event to the control module 22. For instance, FIGS. 7A and 7B illustrate tracking results for a subject walking, with an original “webcam” image 702 (7A) and the extracted silhouette of the subject 704 and their shadow 706 (7B). As the subject is not in need of assistance, a tracking box 708 shows “green” (in this case in chain dotted lines). When a fall is detected, as shown in FIGS. 8A and 8B, the tracking box 808 may then change state, such as to the colour “red” (as shown by the solid lines), whereby the silhouette 804 is now elongated with very little shadow 806. In the event of an emergency, the control module 22 may instruct the speech dialog module 36 to initiate a conversation with the subject using speech recognition software, such as a small vocabulary, speaker-independent automatic speech recognition (ASR) software. However, other configurations of ASR software, such as speaker-dependent or adaptable ASR, may also be used. This ASR software may be specially trained on population-specific and/or situation-specific voice data (e.g. older adult voices, voices under distress, atypical voice patterns caused by affliction or emergency events). The system may also learn its users' specific voice patterns in an offline or on-line manner during the lifetime of its usage to maximize speech recognition results. Other audio processing techniques, such as real-time background noise suppression, and the recognition of environmental sounds (e.g. falling objects, slam sounds, etc.) may also be employed to ensure robust system performance. As will be discussed in the example below, active measures may also be employed to terminate operation of devices and/or appliances in the area known or observed to cause audio interference, and thus optimize voice ASR performance.

The speech dialog module 36 may communicate directly with the subject by outputting speech prompts via the loudspeaker(s) 48 and listening to audio input via the microphone(s) 34, to determine the level of assistance that the subject may require. The outcome of this speech dialog can be sent to the control module 22 and, if further assistance is required, the control module 22 can relay this to the central server 40 via the communications network 45. Alternatively, or in combination therewith, visual prompts may be used to prompt the hearing impaired (e.g. via images, text and/or speech-to-text displays in or near the area, such as a pixel board, monitor, and/or by patching into the occupants' TVs/computer monitors, or again into a mobile device such as the occupant's smart phone or similar therefore further allowing the occupant to interact with the system through tactile menu options, etc.), as can one or more physical input interfaces (e.g., a specialized keypad or touchscreen) be used for those unable to respond orally to reply to such prompts. In some embodiments, speech synthesis technology (e.g., text-to-speech), may be used in addressing occupants in rooms. For example, the voice pattern of the speech synthesis system may be customized or trained with the voice patterns of a particular person, e.g., a familiar and trusted voice, for instance to allow people with afflictions such as Alzheimer's or dementia to more easily co-operate with it.

An alternative example implementation of the system 10 may allow for emergency situations to be detected by either the video processing module 32 or the speech dialog module 36 simultaneously. In this configuration, the microphone 34 may be on at all times, allowing the speech dialog module 36 to listen for key emergency words or audio events (e.g. a cry for “help!”, a loud crash), or again to detect distressed and/or atypical speech. This implementation may be particularly useful if the video processing module 32 is unable to detect a given emergency situation (e.g. if the subject is outside the field of view of the camera(s), or during low light conditions such as nighttime).

As an optional feature, the EDR unit 14 may also include a motion sensor 54, such as an infrared sensor. The video camera 30 may also be equipped for “night vision”. This may add additional functionality to the system, such as the ability for a given unit to automatically turn on when significant motion is detected (e.g. when a person enters a room), or for more robust vision tracking in low light conditions (e.g. at nighttime). This functionality may allow the system to also operate in an “away” mode, thereby to detect in-home disturbances or intrusions when the person is not home. Therefore, an additional application for the system may be to act as a home security system or to augment existing home security systems. A light bulb may also be fitted in each EDR unit, so as to be activated by a light switch, for example on a neighbouring wall. If desired, the light on the EDR unit may operate in the same fashion as a conventional ceiling-mounted light fixture, enabling a user to replace or augment existing ceiling mounted light fixtures with functions of the device 10.

The central server 40 is able to handle simultaneous communications with one or multiple EDR units 14, allowing for multiple EDR units 14 to be installed in different rooms of a house, assisted living facility or long-term care facility. Therefore, at a given point in time, the central server may analyze the information simultaneously received from multiple EDR units 14 and determine which EDR unit is currently “active” (i.e., which camera currently has the subject of interest within its field of view). This may be accomplished by comparing the audio and/or computer vision tracking and/or audio processing results from each local processor 20. For example, the EDR unit currently tagged as “active” may be the one currently tracking the object with the largest size or with significant movement. This methodology allows for the central server 40 to track a subject between the cameras of multiple EDR units installed in the same room, or throughout various rooms of a house, ensuring that an emergency event is detected robustly.

Similarly, where more than one EDR is operable to detect a user within or near a same predetermined area, the system may be configured to select as “active” the EDR for which respective data generated thereby achieves a highest ranking, e.g. a highest reliability measure. Also, respective data sets processed from multiple EDRs can be compared to identify overlap therebetween, whereby multiple data sets may be merged based on this identified overlap to achieve greater monitoring, emergency detection and/or response. Accordingly, where more than one EDR can actively track the user, the system may be configured to actively process data from each active EDR to generate a merged data set. Merged data sets may, for example, provide greater locational data with respect to the user (e.g. 2D/3D mapping) as well as greater depiction of the user's status, particularly where only partial images can be rendered by each EDR, for example.

Each EDR may also be adapted for automatic global localization (e.g. real-world coordinates such as longitude/latitude or address), for example via GPS and/or network geolocation, with a possible manual override. Such global localization may prove useful in initiating emergency responses and dispatching an exact location of the emergency event to external responders.

Different embodiments may further include one or more of the following optional features. For example, a given embodiment may include an event interface, whereby a central location controller unit may include an externally addressable interface allowing authorized third party clients to receive event data, such as emergency factors and other information gathered by the local processors, and act on it. For example, the event interface may allow authorized users to send event information to external notification methods, publish emergency events, import contact data and data storage, interface with web-services and social networks, GPS/locational information for emergency response and positional information for tracking the position of people in their environment (e.g. used in applications such as extracting, analyzing, or using patterns of living). In addition, such data may be correlated with other sensors in the environment such as pressure sensors, motion sensors, “smart-home” sensors, etc., for instance for improving the accuracy of emergency detection and 3rd party applications.

In some implementations, smart-home devices may also be used in the context of the herein described system to ensure user safety. For example, ensuring lights are on in the rooms people are present in or about to enter to prevent falls, or ensuring that the stove is turned off when a person leaves it unattended, e.g. when user is detected leaving the kitchen, may contribute to improved user safety. The central controller may also implement the functionality of a central “smart-home” controller or module, allowing user interfaces to smart home devices, for example, or again to interface with regular devices via one or more communicatively accessible intermediary devices, such as wirelessly addressable relays, switches and the like.

In one exemplary embodiment, a controller of the emergency detection system may be configured to communicate with one or more smart-home devices such that the system may be configured, in accordance with one or more emergency detection and/or response protocol, to control at least one smart-home device function. Examples of smart-home devices may include, but are not limited to, devices associated with in-home lighting (e.g. ambient lights, emergency and/or back-up lighting, etc.), appliances (e.g. stove, oven, fireplace, television, radio, etc.), and other such devices. Furthermore, smart-home devices may include, as contemplated herein, devices providing direct communicative access thereto (e.g. incorporating an infrared, radio and/or other direct receiver), networked devices (e.g. communicatively accessible via wired and/or wireless (Wi-Fi) network such as via the Internet or the like), as well as devices operatively and/or communicatively coupled to an intermediary device that is itself communicatively accessible by the controller for effectively controlling the device(s) of interest. Examples of smart-home control technologies considered within the present context may include, but are not limited to, smart/intelligent domotics, power outlets, appliances and relays, to name a few. Namely, devices contemplated within the present context are not limited to “smart” devices comprising integrated electronics or the like, but rather, may also include various devices operated by an on/off relay, for example, and that can thus be operated by the system to be turned on or off as needed.

In one embodiment, when the system detects an emergency or adverse event, or when the system is activated by a person in the home (i.e., a user), the system may be configured to turn off or on one or more designated devices communicatively coupled thereto, for example as defined by one or more preset response protocols. For example, the system's controller may be configured to turn on or off one or more devices, lights, appliances, electronics, etc. in the home.

In such embodiments, this feature can greatly improve the system's ability to control/alter the environment, improve detection of the event, and/or provide assistance to the user. In one example, the system can be configured to control the provision of power (e.g. remotely actuated relay, switch or device) to one or more designated devices identified as being the potential source of background noise in the implementation of the system's response protocol(s). Accordingly, upon detecting an adverse event, and where the system is configured to respond to audio cues or commands, or again implement a virtual dialogue with the user in such circumstances (e.g. via speech recognition or the like), the system's controller, or local detection and response unit, may be configured to turn off one or more such devices, thus reducing the likelihood of background noise interfering with the system's audio implementation. For example, previously identified sources of potential interference such as a TV, radio, appliance (e.g. dishwasher, hood fan, etc.) may be operatively controlled by the system to reduce or eliminate conflicting sources of noise, thus allowing the local detection unit to better “hear” the user during a detected event. Moreover, the system may be configured to turn off appliances, running water, etc. so that the user and home are kept safe during an event (e.g. less risk of fire, flooding, etc.).

It will be appreciated that while certain embodiments, as described above, rely on the joint processing of data acquired via two or more distinctly located detection units, the examples considered here may be implemented from a single detection source. For instance, in the exemplary scenarios described below, the system is configured to automatically select audio captures provided by a selected one of two or more detection units identified as most likely to provide an accurate capture, for example, where an interfering audio source is detected. In embodiments where power to such interference sources may be controlled by the system, the system may rather be configured to turn off such sources, thus potentially simplifying the detection and response protocol of multi-sensor systems, or again in the context where a single detection unit is available within a given area.

In other such embodiments, the system may also, or alternatively, be configured to control lighting so to improve the system's ability to detect the user or its environment, i.e. under improved or optimized lighting conditions. As such, the system may be configured to “see” better and therefore make better decisions. Additionally, it may be comforting to the user to have the lights on in an adverse event situation, rather than to potentially suffer in the dark. Lighting could also be a safety feature; if there were a fire, all the lights could be turned on so the occupants could see.

Similarly, the system may be configured to turn off any or all power, gas, water (e.g. in the event of an oil fire), etc. to rooms or areas of the home in the case of a fire. This could help prevent the spread or worsening of the event.

Furthermore, via the system's speech recognition and vision capabilities, the occupant could control devices in the home, via speech and/or gestures, in an emergency or non-emergency event. For example, users could themselves instruct the system to turn on or off electrical devices in the home, gas, water, etc.

In some embodiments, if an adverse event was detected, such as a fire or carbon monoxide detection, the system can be configured to notify the occupants and emergency response where the fire is and, potentially, what type of fire it is (e.g. via chemical composition of smoke, smoke colour, etc.). In such embodiments, instructions could be given to the occupants as to safe exit routes. For example, if there was a fire in the kitchen and people were upstairs, it could tell them to leave the house via the front door.

In some embodiments, control over devices such as the stove and bath could be used outside of adverse event detection or user-initiated control to keep accidents from occurring. For example, if the user was running a bath and the water level went too high (e.g. above a predefined level), the water could automatically be shut off to prevent overflowing.

Similarly, if flooding was detected (e.g. using vision, sound and/or other detection means), such as in the event of a toilet, dishwasher, or washing machine overflow, or a pipe in a wall bursting, the user could be notified and water to the area or device shut off by the system.

In these and other such embodiments, access to the home by emergency personnel, family members, etc., could also be enabled by the system or user by unlocking door(s). Similarly, to enhance security, for example, if a potential threat was detected outside the home by the system, another security system, or user, the door(s) could be locked.

As discussed above, configuration of the system to effectively control activation, deactivation and/or operation of one or more devices in the home may thus allow for various features and advantages both in event detection and response, but also in event prevention and safety.

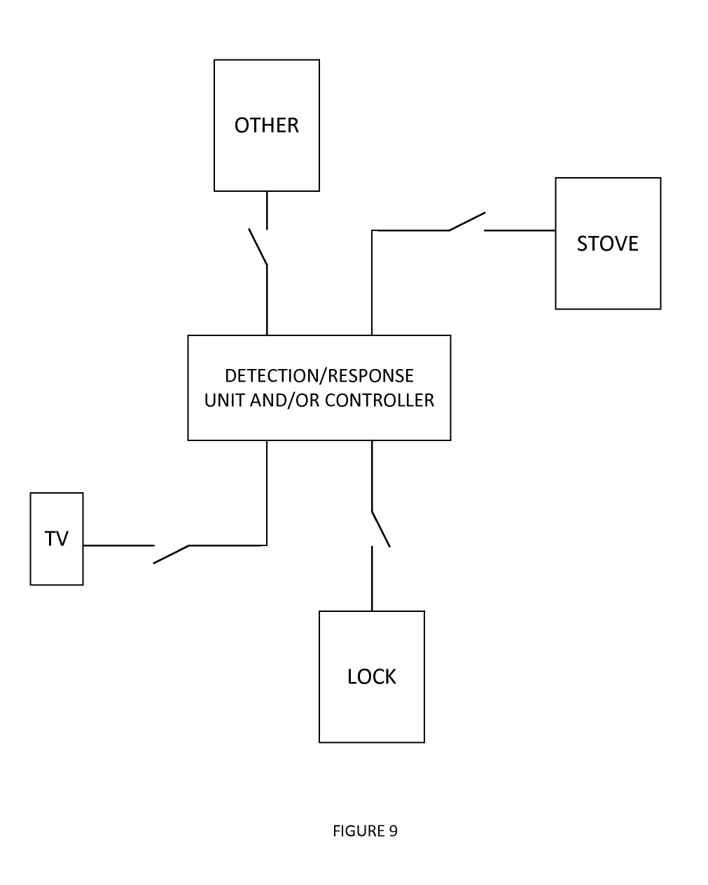

FIG. 9 provides a schematic diagram of an emergency detection and response system 900, in accordance with one embodiment of the invention, wherein the system 900 is configured for communication with at least one smart-home device, illustratively depicted herein as a TV 902, stove 904 and lock 906, wherein the system's controller 908 is effectively configured to control one or more switches or the like in activating or deactivating one or more of these devices.

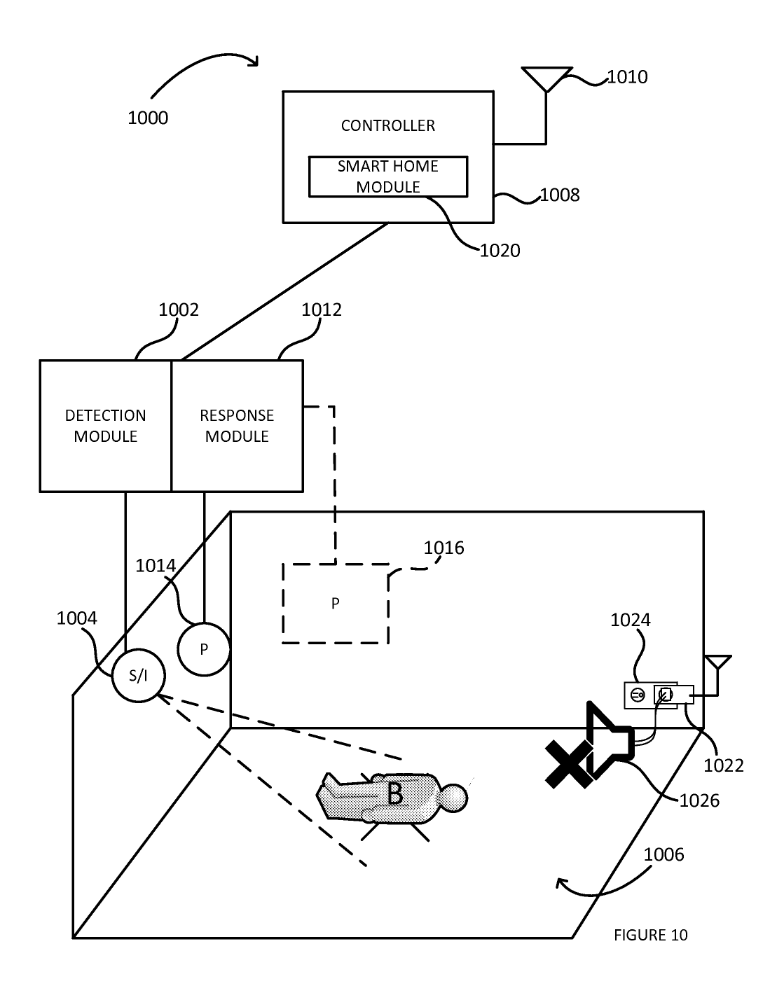

With reference to FIG. 10, an illustrative example will be described of a system 1000 in which interfering sounds are automatically terminated in response to a detected event so to improve implementation of the system's voice recognition features, for instance in facilitating audio capture of user's verbal exchanges with the system during implementation of an severity assessment protocol in respect of an automatically detected event.

In this particular example, in which like numerals are used for like parts as previously introduced in relation to the embodiment depicted in FIG. 2, the system 1000 generally comprises one or more detection modules 1002 each adapted for operative coupling to one or more sensors, as in sensor 1004, which are distinctly disposed in or near a predetermined area 1006 to detect emergency events occurring in or near this area (e.g. in respect of user B). The sensor 1004, in concert with detection module 1002, is generally configured to generate a data set representative of a detected event.

The system 1000 further comprises one or more controllers 1008 operatively coupled to each detection module 1002 and configured to evaluate the data set and implement a response protocol as a result of this evaluation. While not explicitly shown in this example, various data set ranking and/or merging techniques may also be used in the context of the present example to enhance performance of the system, for example.

In this embodiment, a response module 1012 is associated with the detection module 1002 and adapted for operative coupling to a prompting device 1014 and input device, which in this embodiment, is commonly operated via sensor 1004. Accordingly, upon the controller 1008 processing a data set, a response protocol may be selected and implemented in which the user B is first prompted via an appropriate response module and prompting device to provide a user input in return, which user input can then be relayed to the controller (or local response module) to refine, adjust and/or terminate the response protocol. In the examples described below, a prompt is provided via a selected prompting device, and a user input is recorded in response thereto. In the event where the sensor 1004 includes an audio sensor (e.g. microphone, microphone array), this audio sensor may double as input device for recording the user's response.

Again, various device combinations may be used to achieve this result without departing from the general scope and nature of the present disclosure. For example, a combined detection and response unit encompassing the functionality of both detection and response modules may be considered, as can a self-contained processing unit further encompassing at least some of the processing functionalities of the controller, to name a few. Furthermore, and as depicted by prompting device 1016, an additional or alternative prompting device, such as a visual prompting device for the hearing impaired (e.g. communal or dedicated screen) may be used by respective response modules or shared between them in prompting a user response.

In one embodiment, the controller 1008 may be configured to dispatch an emergency message or warning to an external user (e.g. via antenna 1010), based on the processed sensory data and/or user responses.

In this particular embodiment, the system 1000 further comprises a smart home module 1020 integrated, in this example, within the system's controller 1008 to provide one or more smart home features and/or functions to complement the system's emergency detection and response protocols. In this particular example, the smart home module 1020 is preconfigured to communicate wirelessly with local wirelessly actuated relay 1022 that can control a local device's access to power from a regular wall outlet 1024 or the like, for example. For instance, where a device, such as audio device 1026, is known to be commonly operated in a manner that could cause audio interference for the normal or effective operation of the system's voice recognition functions, this device 1026 may be connected to the outlet 1024 via the relay 1022, thereby allowing the controller 1008 to automatically cut power to the potentially interfering device 1026 upon detecting an emergency event in the area 1006. In one example, the device 1026 may consist of a television or radio, which, if operating when an adverse event is detected, may cause significant interference with the system's ability to assess the situation, particularly if the device 1026 is operated loudly and/or if the user is not in a position to speak loudly and/or clearly. In such instances, the system may be predisposed to automatically communicate with the relay 1022 to cut the power to the device 1026 and thus immediately remove interfering noises/sounds emanating therefrom.

In a similar embodiment, the relay 1022 may be further comprise a current sensor to first identify whether the designated device 1026 is operating and communicate this operating status to the smart home module 1020 and controller 1008, in response to which, an appropriate command may be communicated back to the relay 1022 in the event that interfering sounds are to be minimized. Similar to the current sensor/relay contemplated in this example, other devices may also be considered to provide similar effects, such as, but not limited to, smart light switches, motion sensors, contact sensors (e.g. operatively disposed on a refrigerator and/or medicine cabinet or drawer), water meter (e.g. disposed under a sink and which may be configured to work in conjunction with a contact sensing device to detect water meter pulses).

As will be appreciated by the skilled artisan, other devices may also be included in this context to reduce the possibility for background noise and/or sounds, such as different household appliances (dishwasher, microwave, hood fan, washing machine, etc.), and the like. Further, while the above contemplates the use of a distinct wireless sensor/relay, other means may be readily considered in this context to provide a similar effect, such as device integrated relays, network enabled devices (e.g. smart TV and/or appliances) and the like.

In some embodiments, each device and/or relay may be addressable individually, thereby allowing the system 1000 to interface with each device distinctly, for example, in terminating or at least reducing audio interference in the area of interest 1006. In other embodiments, the system 1000 may rather be configured to actuate each relay/device globally, thereby affecting each area equally irrespective of the location of the event. These and other such permutations of the above will be readily apparent to the person of ordinary skill in the art.

As noted above, while the example shown in FIG. 10 contemplates the reduction of audio interference by way of automated remote device actuation control(s), other embodiments may rather, or also, automatically provide for improved visual conditions in facilitating a response protocol. For example, as noted above, where a given embodiment be configured to record and optionally communicate still or video images in the context of emergency event detection, response and/or reporting, the system may be configured to automatically adjust lighting conditions in the area of interest, or globally throughout, to facilitate not only image capture, but also improve assessment of the situation and reporting functions. Such lighting adjustments may also permit enhancement of the user's comfort, who may have fallen for example when moving about in the dark, and who may feel increasingly vulnerable if left scrambling in the dark.

Different approaches may be relied upon to provide connectivity and ultimately control between the controller and/or detection/response units and selected devices. For example, a smart-home device control function or subroutine may be called upon by the controllers main processor in response to a detected event, whereby this called function or routine may be preconfigured to address designated devices via respective communication ports, be they wired or wireless ports enabled for communicating one or more commands to the designated device(s) in operating the device in accordance with a designated protocol. Different call functions may include basic on/off commands for interrupting power to a selected device, either directly or via an intermediating relay, power up/down commands for adjusting, for example, volume or light output settings of a selected device, or more complex commands as will be readily appreciated by the skilled artisan. Further, different connectivity settings and protocols may be implemented, as can different networking systems and setups contemplated depending on the complexity and vastness of the system's implementation and intended purpose. For example, some smart home sensors/devices can provide for network connectivity using standard Ethernet/Internet protocols, wireless connectivity (Wi-Fi, Bluetooth, etc.), and/or connectivity over power lines, to name a few. In some examples, smart home sensors/devices may provide for dual band connectivity, for instance responsive to both power line and wireless communication protocols.

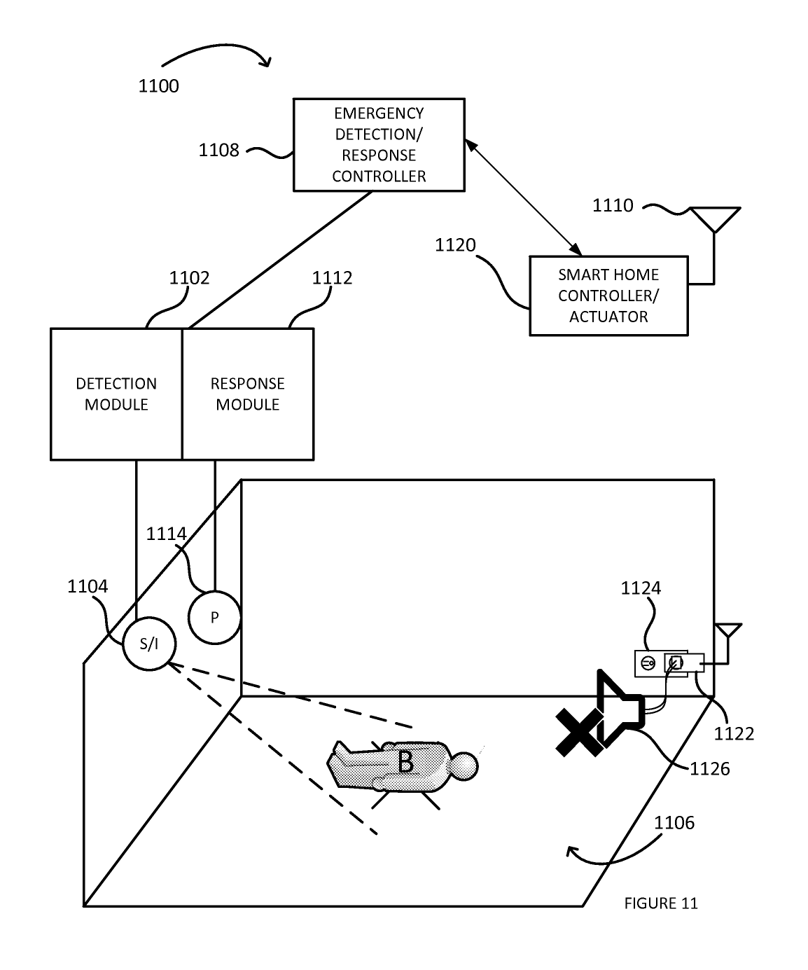

With reference to FIG. 11, and in accordance with another embodiment, the system 1100, similar to system 1000 of FIG. 10, in this embodiment comprises a distinct smart-home controller/actuator 1120, which communicates with the system's controller (EDR controller) 1108 to provide one or more smart home features and/or functions to complement the system's emergency detection and response protocols. In this particular example, the smart home controller 1120 is preconfigured to communicate wirelessly (i.e. via antenna 1110) with local smart-home sensors/relays 1122 to control a designated device, such as device 1126. In this particular example, the EDR controller 1108 is again configured to detect an adverse event via detection module 1102 and sensor(s) 1104, in response to which, a request is sent to the smart-home controller/actuator 1120 for information as to the operational status of the designated smart-home device 1122, namely to assess the environment around the detected event. The smart-home controller/actuator 1120, in response to the EDR controller request, probes the designated device(s) 1126 via sensor(s) 1122, and returns a value to the EDR controller 1108 indicative of the operational status of the probed device 1126 (e.g. TV is “on”). The EDR controller 1108 then processes the received device status value against preset rules to output an appropriate control command to be applied to the designated device 1126 via the smart-home actuator 1120 and device 1122 (e.g. when TV status=“on” then output “power off” command).

Upon completion of the above smart-home control subroutine, or concurrently therewith, the EDR controller may proceed with implementation of a selected response protocol (i.e. via response module 1112) whereby the occupant may be prompted, in one embodiment via prompting device 1114 to provide a verbal response to be automatically processed by a speech recognition software to ascertain a level of assistance required.

In one particular example, a central EDR controller or server can be provided remotely to monitor, detect and respond to emergency events in plural areas, for example via communicative access to respective local detection and response modules, and further communicate with a local smart home controller to both probe the environment of the user in the event of an emergency, but also implement one or more smart-home control commands to improve responsiveness of the system and/or improve user safety, comfort and/or access by on-site emergency respondents. Alternatively, local EDR controllers may be provided locally to communicate with local detection and response modules, for example via a home network (e.g. Ethernet, Wi-Fi, etc.)

Examples of the above components may include, but are in no way intended to be limited to, Smarthome® sensors, switches and/or components provided by Insteon®, smart home controllers/actuators such as those provided by GoodRobot, and other such devices and/or components as will be readily appreciated by the skilled artisan.

These and other such considerations will be readily appreciated by the skilled artisan and are therefore deemed to fall within the general scope and nature of the present disclosure.

In some implementations, the central location controller unit and/or the local units may be interfaced by users and/or administrators over a local or remotely accessible interface, such as a database-backed or configuration-file based webpage configuration. This interface may allow the users to set preferences on event notification, account settings for 3rd party interfaces, etc. In addition, an administrator configuration may include advanced fine-tuning options for the emergency factor along with debugging information.

In some implementations, online learning may also be implemented to adjust parameters of the system in response to learned user preferences, such as a user's preference for emergency response criteria (e.g. detection sensitivity, timeout on user prompts for automatic emergency calls, etc.). For example some users may have slower responses to voice prompts than others, and the system may learn to wait longer for a response. Some users may be more or less independent than others, allowing the system to learn user's tolerance preferences for help/emergency response in order to preserve dignity and a sense of independence, for example.

FIG. 6 is a flow diagram outlining this decision-making process performed by the central server 40, which may communicate with multiple EDR units 14 simultaneously. At step 301, the central server 40 receives emergency monitoring results from the EDR units 14, as shown in FIG. 3A, with the three EDR units 14 on the left side of the space 12 reporting with the message on data paths 14b. This connection 45 may be a wireless network connection (Wi-Fi) or some other type of communications connection. The emergency monitoring information received by the central server 40 may include complete or partial results from the analysis of video input and/or audio input from each EDR unit 14. For example, video analysis results may include information such as: the presence or absence of an object of interest (e.g. human user or other object) in the camera's field of view, size and movement of the object, etc. Similarly, audio analysis results may include: the presence or absence of a significant audio event of interest (e.g. speech, loud crash noise), the detected loudness of the audio event, etc. Other important video/audio monitoring results may also be received at this step depending on the nature of the video/audio analysis performed by the EDR units.

At step 302, the monitoring results received from all EDR units 14 are compared, and the central server 40 decides which EDR unit 14 is currently in a fully “active” state. In order to do this, the central server 40, via ranking agent 50, ranks all the received emergency monitoring results according to a set of ranking criteria (e.g. digital imaging, video and/or audio analysis criteria and thresholds). These analysis criteria and thresholds may be fixed or dynamic depending on a given video or audio scenario. Such ranking criteria may include video analysis metrics such as the current size of the object being tracked, if present, by each video camera 30, and audio analysis metrics such as the current amplitude of audio or speech, if present, captured by each microphone 34. For a given point in time, the EDR unit 14 with the highest rank may then be chosen to be the currently “active” EDR unit 14. Using these ranking criteria may ensure that the chosen active EDR unit will be the unit that is currently best suited for monitoring the human user and detecting and responding to possible emergency events. In this case, the system will continue to receive EDR data on a regular basis as the subject progresses through a particular monitoring time period, either in a single monitored location or in a plurality of monitored location. This may involve several ceiling or otherwise mounted EDR units mounted throughout the location(s) and one central controller that supervises and coordinates the monitoring operations of the EDR units.

In the interests of minimizing power consumption and extending the life of the EDR units, an embodiment employing a central controller may be configured to employ predictive modeling to determine a predicted location of an occupant. In this case, the central controller may activate (power-on) tracking units that are located in areas that are proximal to and currently containing the occupant(s). Areas that are not in use by the occupant(s) may be kept in a standby (power-save) mode. Predictive algorithms may be employed to determine the areas the occupant is most likely to move to, activating tracking units that are located in the areas along the occupant(s)' likely path of travel. During periods of inactivity, the central controller may be used to place all units on standby except those monitoring areas of critical interest. Examples of this include monitoring only a bedroom location, while the occupant is asleep or only the entrance area if the occupant has left his/her home.

Once the active EDR unit has been chosen, the central server 40 may notify all EDR units 14 of this decision, and/or notify only the currently active unit to continue with the full detection of and response to an emergency event, the latter case shown by path 14c in FIG. 3B. This decision-making framework by the server may prevent multiple EDR units from detecting the same emergency event and confusing the user by all starting a dialog with the user simultaneously. Thus, the EDR units are operable to sense data either continuously, regularly or periodically, thus dispatching signals to the central controller continuously, regularly or periodically and then being responsive to the central controller to be selected for implementing dialog with a subject. Therefore, the communication with the subject occurs following (and not before) selection of an active EDR, according to prevailing emergency factor data. That being said, the active status of a selected EDR at time T=T1 may not be effective at time T=T2, if the emergency factor data indicates a change, as may occur if the subject were to slip and fall in a bedroom (at T=T1) and then stand up and stumble into a neighbouring hallway. In this case, a successive train of EDR's may be activated and then deactivated, in succession, as the subject moves.

The active EDR unit 14 is then operable to monitor the user and detect if an emergency occurs (e.g. a fall). If such an event does occur, this information may be relayed back to the server, which may in turn instruct the active EDR unit 14 to initiate a dialog with the subject using speech recognition software to determine what level of assistance may be required (steps 304 and 307). For example, a user's response to one or more prompts initiated by the EDR unit 14 may be automatically captured and recognized by the speech recognition module, and compared with preset responses in evaluating a level of assistance required. Clearly, the absence of a response may also be processed as indication of required assistance, for example where the user is unconscious or no longer able to communicate verbally.

In one embodiment, the system may further act on one or more designated smart-home devices (step 350) to improve or optimize capture of the user's condition, for example by reducing interfering noises emanating from previously identified devices in the area of interest or globally in the user's residence, or again by adjusting light conditions for optimal video capture. In one such embodiment, the system may be preconfigured to automatically turn off interfering sound devices and/or adjust lighting upon detecting an adverse event so to optimize capture of the user's condition. Also, or alternatively, control of designated smart-home devices may be automated upon detection of an adverse situation so to promote user safety, for example by turning off appliances that could exacerbate the situation (e.g. turn off oven/stove to avoid a fire, turn off tap water flow to avoid a flood, etc.), or again by adjusting lighting conditions to increase user comfort and/or facilitate delivery of personal assistance to the user. Once again, a smart home device will be understood to broadly encompass one or more devices either integrally manufactured to provide wired, networked and/or wireless connectivity for the purpose of remote/network/central operation, or again powered and/or controlled via an intermediary device such as a relay or the like adapted to provide such connectivity and thus effectively render a device operatively coupled thereto to operate as a smart-home device.

If the active EDR unit determines that the user does require assistance, this information may be relayed to the central server 40 (step 308). The central server 40 may then initiate the appropriate communication about the detected emergency situation to the outside world (step 309). Depending on the type of assistance required the system could notify a neighbour, relative, medical staff (e.g. family doctor), emergency services (e.g. 911), or other appropriate personnel, via the external interface unit 52. Furthermore, this communication may occur via a variety of possible communications protocols, such as landline phone, cell phone, email, text message (SMS), or some other communication system.

As an optional configuration, at step 303, information about the current monitored behaviour of the user may be used to update a learned model of the user's daily “normal” behaviour and routines. This model may contain information about time of day and duration spent in certain locations of a house, etc. In this example, the EDR unit or central server may employ artificial intelligence algorithms (e.g. Markov Decision Process methods) to enable the system to gradually learn the expected daily behaviours of a given subject. This may allow the overall system to detect emergency situations more robustly by further characterizing “normal” versus “abnormal” behaviour for a given subject, which is done at steps 305 and 306. For example, if the subject is spending significantly more time in bed and less time in the living room than he/she normally does on a given day, this may be an indication of declining health (e.g. physical health issue such as flu, or a mental health issue such as depression). Since such a situation may not indicate an immediate emergency, the central server 40 may still tell the active EDR unit 14 to initiate a dialog with the user (step 307) that is adaptable and appropriate for the particular situation to determine if any assistance is required. For example, the system could ask the user if everything is ok because it appears they have been in the bedroom all afternoon. The active EDR unit 14 could perform these tasks by employing adaptable speech dialog technologies such as Text-To-Speech (TTS) software in conjunction with automatic speech recognition (ASR) software.

As a further optional configuration, in the case where multiple EDR units 14 are used, some or all of the EDR units may have a scaled-down local processor or may even have no processor at all. In this case, such EDR units may not perform full video processing or speech/audio processing, but may send video and audio data over the communications network 45 in real-time to either be processed by central server 40 or by a nearby EDR unit that does contain a fully functional local processor 20. This type of network configuration may be advantageous in some scenarios due to the centralization of video and audio processing for the system 10, which may make the system more affordable by reducing hardware and software costs of the EDR units. Furthermore, EDR units without a fully functional local processor 20 may be constructed using a smaller housing 14a, which may make them easier to install throughout a home as well as more aesthetically pleasing to the user.

In yet another optional configuration, there may be instances when the occupant will be located on or across the edge of the field of view of an EDR unit. When possible and necessary, images from overlapping EDR units' field of views may be delivered to the central computer and be stitched together to provide complete image of the subject, for later analysis. In other embodiments, distributed computing techniques may alternatively allow for neighbouring units to process overlapping fields of view and thus provide a complete image of the subject for later analysis.

In cases such as this, the control module 22 may not assign a value to the emergency factor according to the data received from either the video processing module or the speech dialog module, or both, as the case may be, but rather transmit the raw video data image or images to the central controller, which may then assemble an image or images from the control unit of a neighbouring EDR unit in order to assemble a full image of the combined field of view, so that the emergency factor may then be valued based on this merged data set.

For exemplary purposes, the device 10 may be operated as follows. In the event of an adverse event, such as a fall, the units that are closest to the occupant may “view” and “listen” for input (e.g., commands and responses) from the occupant. The input received by each EDR unit (hereinafter referred to below as a ceiling mounted unit (CMU)) may then assigned a confidence factor (CF), which may indicate what the likelihood is that the input from the occupant perceived by the system matches an actual verbal input from the occupant. The CF may be influenced by aspects such as (but not limited to) CMU proximity to the occupant, ambient noise levels, and word recognition error rate (WRER, which is estimated by the speech recognition software), and may be calculated using a function similar to the one described in Equation 1:

CF=1/[β1(proximity)+β2(ambient noise level)+β3(1−WRER)] (1)

where β1, β2, and β3 are constants determined through a combination of within-lab experimentation and calibration once the system is installed in an environment. Post-installation calibration may be necessary, as the layout of the environment may influence the acoustics, to determine each CMUs' “hearing” range.

The CMU that rates the occupant's response with the highest CF may then dictate action by the central control unit. This unit may not necessarily be the CMU closest to the occupant (as demonstrated in the scenarios below).

A situation may occur where an occupant has an adverse event in a visual monitoring area covered by two or more CMUs. As the images from the units may be stitched together, an entire image of the occupant may be available to the system.

The system may also be designed so that the occupant may activate the system using a keyword (e.g., “Help!”), to enable the occupant to procure assistance regardless of whether s/he is visible by the system. In this instance, the system may determine the occupant's most likely responses using verbal input only. The unit that has the highest CF may be the one relaying responses, although since the proximity will be unknown, Equation 1 may be altered to reflect this (such as a ‘0’ value for proximity). Other options for alerting the system may include a standard push button or activation of a smart home device or unit, for instance where the user is not generally capable of communicating verbally.

Reference will now be made to the following non-limiting example, in which some of the above-proposed approaches to signal classification are applied to the classification of physiological signals, in accordance with exemplary embodiments of the invention.

### Example

The following scenarios are presented for illustrative purposes only. Consider that a subject experiences an adverse event near a source of sound interference, such as a television, as depicted at 13 in FIG. 3A. For the sake of simplicity, assume the distance to CMU #1 is 3 meters (d1=3) and to CMU #2 is 8 meters (d2=8) and (notionally for the purposes of this example), that proximity has the least impact on a CMU's ability to “hear” verbal input (β1=0.2), ambient noise has the most impact (β2=0.6), and WRC is somewhere in between (β3=0.3). Assume that the constants β2 and β3 are the same for both units. Note that as distance is in meters, ambient noise is an exponential measure (dB), and the WRER is expressed as a percentage, the constants β1, β2, and β3 for a particular application may be established through empirical testing. The actual values for β1, β2, and β3 will depend on the specific configuration of the device 10, the physical characteristics of the location being monitored, as well as the general health of the subject. For instance, for an application in which a subject is only able to whisper, the constant β2 may be set to a higher value, when compared with the same location with a subject who is able to speak at a normal speaking volume.

### Scenario 1: Television Off

If the television is off when the same adverse event occurs, there may be no dominant competing noise to interfere with communication. Assuming the room is quiet (25 dB) and the WRER is 5%, or 0.05, the CF for the two CMUs may be calculated as:

CF1=1/[0.2(3)+0.6(25)+0.3(1−0.05)]≈0.060

CF2=1/[0.2(8)+0.6(25)+0.3(1−0.05)]≈0.057

As the CF for CMU #1 is higher than the one for CMU #2 (i.e., CF1>CF2), the input received by CMU #1 will be considered to be more reliable and therefore used by the central control unit to make decisions.

### Scenario 2: Television On

Assume that the television is on at a volume of 70 dB when the adverse event occurs, creating a source of interference. As CMU #2 is further from the occupant than CMU #1, it is also further from the competing noise source and thus has less competing ambient noise, for example, 50 dB and 65 dB respectively. Moreover, while the television and the occupant are approximately equidistant from CMU #1, the occupant is closer to CMU #2 than the television is. The CF for the two CMUs might be:

CF1=1/[0.2(3)+0.6(65)+0.3(1−0.05)]≈0.025

CF2=1/[0.2(8)+0.6(50)+0.3(1−0.05)]≈0.031

In this case, the CF for CMU #2 is higher than the CF for CMU #1 (i.e., CF1<CF2). Thus the verbal input received by CMU #2 may then be used by the central control unit to determine the appropriate action(s) to take.

Thus, an exemplary embodiment operates through one or more CMU's and a central control unit, where the CMU's are mounted to the ceiling, resulting in improved monitoring coverage while ensuring that the EDR units are unobtrusive and discrete. Each CMU includes a vision sensor, in this case as a non-recording video camera. The CMU also includes a microphone, one or more speakers, a processor, and a smoke alarm. Multiple CMR's may thus be used and networked together to ensure that designated areas of a monitored facility, such as a subject's home, may be monitored. One central controller may thus be installed in each home and be responsible for coordinating the CMU's and relaying communications to the outside world.

In one example, the system 10 may use computer vision techniques to track a subject as the subject moves about the subject's home and detects if there is an acute emergency event, such as a fall or a fire. In this case, the vision sensor does not record, transmit, or store collected images. The system does not provide continuous data about the subject's status and activities to an external source, thus preserving the subject's privacy. When an acute event is detected, one or more CMU's sensing the event dispatch event data to the central controller which then selects either the closest CMU, or another CMU with improved sensing results for the event, to be an active CMU to employ speech recognition algorithms to have a dialogue with the subject in distress to determine if and what type of assistance is required. In this case, 911 and the monitoring provider's live switchboard may be made available as needed, in some cases based on prior and/or on the spot permission from the user/occupant, as well as one or more respondents that were predefined by the subject (e.g. a neighbour, a family member, and/or a friend). By verbally answering a short series of simple “yes”/“no” questions, or other simple verbal phrases, the subject may select which respondent s/he would like to contact.

To further improve the subject's safety, if the system 10 does not hear a response from the user during an acute event, the system may connect to a live operator at the provider's switchboard, and/or to a respondent on the user's preset response list, to assess the situation and provide appropriate assistance. Through the selection of the type of aid s/he would like to receive, the subject may thus remain fully in control of the situation and his/her health, promoting feelings the dignity, autonomy, and independence without compromising safety.

In a further embodiment following from the above example, the system may further or alternatively be configured to address the device 13 directly or indirectly as a designated source of interference. Namely, and as discussed in greater detail above with reference to the embodiment of FIG. 10, the system's controller or related device may be configured to communicate a preset command to the designated device upon detection of an adverse event, to either reduce the volume of the device 13, or again turn it off completely, such as via an integrated or intermediary smart-home port or relay, as discussed above.

Thus, the system 10 provides, in one example, an automated emergency detection and response system that uses computer vision to detect an emergency event, such as a fall, and speech recognition and artificial intelligence to then determine the level of assistance that is required by an individual. These devices may be networked together with a central server 40 to provide more comprehensive monitoring throughout an entire living environment, without the necessity of having an older adult wear an alert device or call button. A wearable push button may nonetheless be used in conjunction with the above described embodiments, for example as a back-up or secondary detection measure, or to provide greater system versatility.

While the present disclosure describes various exemplary embodiments, the disclosure is not so limited. To the contrary, the disclosure is intended to cover various modifications and equivalent arrangements included within the spirit and scope of the appended claims. The scope of the following claims is to be accorded the broadest interpretation so as to encompass all such modifications and equivalent structures and functions.

1. A system for detecting and responding to a potential emergency event occurring in respect of a user in or near a designated area, the system comprising:
one or more sensors disposed in or near the area;
a controller operatively coupled to said one or more sensors to receive sensor data therefrom indicative of the user's condition, said controller further operatively coupled to a designated device in or near the area, operation of said designated device previously identified to effect capture of said sensor data, said controller operating on stored statements and instructions to:
process said sensor data in automatically identifying the event therefrom;
communicate a command to said designated device to alter operation thereof based on said previously identified effect so to improve capture of additional sensor data; and
process said additional sensor data to determine a level of assistance required by the user in response to the event.

2. The system of claim 1, said one or more sensors comprising an audio sensor for capturing audio data, said designated device comprising an audio device previously identified to cause audio interference with said audio sensor during operation, said command comprising at least one of a volume reduction command and a power-off command to automatically reduce said audio interference upon identifying the event and thus improve capture of said audio data in determining said level of assistance required.

3. The system of claim 2, further comprising a prompting device for prompting the user, upon identifying the event, to provide a verbal response indicative of said level of assistance required, said verbal response captured by said audio sensor, said additional data comprising said captured verbal response.

4. The system of claim 3, further comprising an automated speech recognition module, said module operated to recognize and compare said verbal response with preset responses classified as a function of respective levels of assistance required.

5. The system of claim 4, said one or more sensors comprising a video sensor for capturing video data of the user, the system further comprising a video processing module for processing said video data in identifying the event.

6. The system of claim 1, said controller directly communicatively linked to said designated device for communicating said command directly thereto.

7. The system of claim 1, said controller communicatively linked to said designated device via an intermediary device, said command being communicated to said intermediary device to alter operation of said designated device.

8. The system of claim 7, the system further comprising said intermediary device.

9. The system of claim 7, said intermediary device comprising a relay operatively coupled between said designated device and a power source for said designated device, wherein said command comprises a power-off command and wherein said relay is preconfigured to interrupt power to said designated device upon receipt of said command.

10. The system of claim 9, said one or more sensors comprising an audio sensor for capturing audio data, said designated device comprising an audio device previously identified to cause audio interference with said audio sensor during operation, said power-off command thus eliminating said audio interference emanating from said audio device upon the system identifying the event, thus improving capture of said audio data thereafter in determining said level of assistance required.

11. The system of claim 1, said one or more sensors comprising a video sensor for capturing video data representative of the event, said one or more designated devices comprising a light source previously identified to effect video capture by said video sensor, said command comprising a lighting adjustment command predefined to improve said video capture.

12. The system of claim 1, the event comprising a fall of the user, said sensor data comprising video data, said controller comprising a video processing module for automatically identifying the fall from said video data.

13. A method for detecting and responding to a potential emergency event occurring in respect of a user in or near a designated area, the method automatically implemented by a computing device having access to stored statements and instructions to be processed thereby, the method comprising:
monitoring sensor data captured from one or more sensors disposed in or near the designated area and indicative of the user's condition;
identifying the event from said monitored sensor data;
communicating a preset command to a designated device in or near the area, the device previously identified to effect capture of said sensor data, said command altering operation of said designated device in a manner previously identified to reduce said effect and thus optimize capture of additional sensor data; and
processing said additional data to determine a level of assistance required by the user in response to the event.

14. The method of claim 13, further comprising prompting the user to provide a verbal response indicative of said level of assistance required, said additional data comprising audio data representative of said verbal response, said designated device comprising an audio device, said command comprising one of a device volume reduction command and a device turn off command.

15. The method of claim 14, said additional data processing comprising automatically recognizing and comparing said verbal response with preset responses classified as a function of respective levels of assistance required.

16. The method of claim 13, said communicating step comprising communicating said command to said device via an intermediary device.

17. The method of claim 16, said intermediary device comprising a relay operatively coupled between said designated device and a power source for said designated device, wherein said communicating step comprises turning off said designated device via said relay in response to detecting said potential emergency event.

18. The method of claim 13, further comprising:
selecting a response protocol as a function of said determined level; and
implementing said selected response protocol.

19. A computer readable medium having statements and instructions stored thereon for operation by a processor of a computing device to automatically detect and respond to a potential emergency event occurring in respect of a user in or near a designated area by:
monitoring sensor data captured from one or more sensors disposed in or near the designated area and indicative of the user's condition;
identifying the event from said monitored sensor data;
causing communication of a preset command to a designated device in or near the area, the device previously identified to effect capture of said sensor data, said command altering operation of said designated device in a manner previously identified to reduce said effect and thus optimize capture of additional sensor data; and
processing said additional data to determine a level of assistance required by the user in response to the event.

20. The computer readable medium of claim 19, further comprising statements and instructions for causing prompting of the user to provide a verbal response indicative of said level of assistance required, said additional data comprising audio data representative of said verbal response, said designated device comprising an audio device, said command comprising one of a device volume reduction command and a device turn off command.

21. The computer-readable medium of claim 20, said additional data processing comprising automatically recognizing and comparing said verbal response with preset responses classified as a function of respective levels of assistance required.

22. The computer readable medium of claim 19, further comprising statements and instructions for causing communication of said command to said device via an intermediary device.

23. The computer readable medium of claim 22, said intermediary device comprising a relay operatively coupled between said designated device and a power source for said designated device, said statements and instructions further for turning off said designated device via said relay in response to detecting the event.

24. The computer readable medium of claim 19, further comprising statements and instructions for selecting a response protocol as a function of said determined level; and causing implementation of said selected response protocol.

25. A system for detecting and responding to a user having a fall in or near a designated area, the system comprising:
a detection module operatively coupled to one or more sensors disposed in or near the area to capture sensor data and detect the fall therefrom, said one or more sensors comprising at least one video sensor;
a controller operatively coupled to said detection module to implement a designated response protocol upon the fall being detected, said controller further operatively coupled to a designated device in or near the area, said response protocol comprising automatically:
evaluating a level of assistance required from said sensor data;
dispatching a request for assistance in accordance with said level of assistance required; and
communicating a command to said designated device to alter operation thereof based on stored preset home automation rules associated with said response protocol.

26. The system of claim 25, wherein operation of said designated device was previously identified to effect capture of said sensor data, said command altering operation of said designated device based on said previously identified effect so to improve capture of additional sensor data; said controller further processing said additional sensor data to evaluate said level of assistance required.

27. The system of claim 26, said one or more sensors comprising an audio sensor, the system further comprising a prompting device for prompting the user to provide a verbal response indicative of his condition, said verbal response captured by said audio sensor and automatically compared by said controller with preset responses indicative of said level of assistance required, said designated device comprising an audio device previously identified to produce audio interference with said audio sensor.
